(19) United States
(12) Patent Application Publication
(10) Pub. No.: US 2007/0051530 A1
(43) Pub. Date: Mar. 8, 2007

(54) Power and/or telecommunications cable with a crosslinked thermoplastic polyurethane cladding

(76) Inventor: Olivier Pinto, Lyon (FR)

Correspondence Address: SOFER & HAROUN LLP., 317 MADISON AVENUE, SUITE 910, NEW YORK, NY, 10017, US

(21) Appl. No.: 11/509,090

(22) Filed: Aug. 23, 2006

(30) Foreign Application Priority Data
Aug. 26, 2005 (FR) 05 52573

(51) Int. Cl. H01B 3/30; C08L 75/04

(52) U.S. Cl. 174/68.1; 525/457

(57) ABSTRACT

The present invention relates to a power and/or telecommunications cable. The cable includes at least one cladding made by crosslinking a composition comprising a thermoplastic polyurethane, a polyisocyanate, as well as a reactive compound provided with at least one hydroxyl function and with at least one acrylate function.

### RELATED APPLICATION

This application claims the benefit of priority from the French Application No.: 05 52573 filed on Aug. 26, 2005, the entirety of which is incorporated herein by reference.

The present invention relates to a power and/or telecommunications cable provided with at least one crosslinked thermoplastic polyurethane cladding.

The invention finds a particularly advantageous but not exclusive application, in the field of transport vehicles which use a lot of power and/or telecommunications cables operating under severe heat conditions.

Certain thermoplastic polyurethanes are known for providing excellent mechanical properties, good chemical resistance, as well as a quite satisfactory resistance to aging. However, because of the reversibility of the urethane bond, significant lowering of the mechanical properties of these polymers is observed as soon as the temperature rises. Thermoplastic polyurethanes then tend to creep, and this simply under the action of their own weight.

To find a remedy to this difficulty, it is of course possible to crosslink thermoplastic polyurethanes, i.e., create chemical bonds between the macromolecular chains in order to reinforce the global cohesion of the network. Indeed, it is known that increasing the crosslinking density of a polymer quasi-systematically leads to improvement of the heat properties, as well as to a reduction of permeability with respect to fluids and gases, and consequently to a reduction in sensitivity towards possible chemical aggressions.

In the field of cables, crosslinking of a thermoplastic polyurethane is generally carried out by chemical self-crosslinking or by electron irradiation.

In this first case, i.e., the purely chemical route, the polymer should be chemically modified so that it may crosslink by itself within a few days, in free air and at room temperature. Two methods are presently available for carrying out such a transformation, one consisting of grafting the thermoplastic polyurethane with compounds bearing isocyanate functions, the other involving grafting of silane type molecules.

But regardless of the technique used, the heat properties achieved by thereby crosslinked thermoplastic polyurethanes today remain insufficient for a certain number of very demanding fields of application in terms of heat resistance under mechanical stress, as this is the case for example in automobiles. The fact is that at the present time, high temperature mechanical strength of such crosslinked thermoplastic polyurethanes can only be guaranteed up to temperatures close to 175° C.

The physical crosslinking route by irradiation as for it is commonly applied by exposing the thermoplastic polyurethane to a beam of accelerated electrons, and therefore highly energetic electrons. Electronic bombardment is advantageously calibrated so that the transmitted energy is able to induce internal crosslinking of the polymer, via ruptures and then rearrangements of chemical bonds.

This type of crosslinking however has the drawback of requiring extremely bulky irradiation equipment, which involves significant installation constraints, but also a certain lack of flexibility industrially. Such a piece of equipment moreover proves to be particularly costly, which finally makes this technical solution quite prohibitive for many applications.

The technical problem to be solved by the object of the present invention is also to propose a power and/or telecommunications cable with which the problems of the state of the art might be avoided by notably providing substantially improved mechanical strength at high temperatures, while retaining a reasonable cost price.

The solution to the posed technical problem according to the present invention, consists in that the cable includes at least one cladding made by crosslinking a composition comprising a thermoplastic polyurethane, a polyisocyanate, as well as a reactive compound provided with at least one hydroxyl function and at least one acrylate function.

The principle used for making cable cladding according to the invention in a first phase consists of grafting an acrylic resin on a polyurethane chain according to the following scheme:

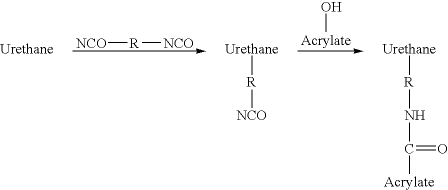

In concrete terms, this amounts to selectively grafting a polyisocyanate along the urethane chains, as indicated in the first part of the previous chemical equation. The thereby obtained isocyanate grafted thermoplastic polyurethane is then able to react with a reactive compound provided with at least one OH function via a standard addition reaction, according to the second part of the chemical equation. If the relevant reactive compound moreover has at least one UV-reactive group, notably of the acrylate type, it then becomes possible to trigger a photocrosslinking reaction in order to reinforce the cohesion of the polymer network.

It is in this way that the principle used for making a cable cladding according to the invention, provides in a second phase for irradiating the grafted thermoplastic polyurethane with ultraviolet radiation. With this operation, which is preferably carried out in the presence of a suitable photoinitiator, a crosslinked thermoplastic polyurethane may then be obtained, with significantly increased thermomechanical performances as compared with its homologues from the state of the art.

In any case, it should be noted here that the notion of cladding very generally relates to any enveloping coating, whatever its shape and whatever its purpose. Thus, this may be indistinctly an insulating cladding and/or a protective cladding.

Moreover it its specified in quite a standard way, the expression “acrylate function” indifferently designates an acrylate group in the strict sense of the term or a methacrylate group.

The invention as thereby defined, has the advantage of making a cable available, for which each crosslinked thermoplastic polyurethane cladding has high temperature performances perfectly compatible with the strictest standards in the fields of automobiles, aeronautics, railways or robotics. A cladding according to the invention actually proves to be particularly resistant to deformation under mechanical stress, and this up to high temperatures close to 200° C.

The proposed solution is moreover easy to apply as it does not require any heavy duty equipment, notably for generating crosslinking of each thermoplastic polyurethane cladding. This operation is actually carried out instantaneously, by crosslinking under the sole action of ultraviolet radiation. In this respect, it should be noted that solar light proves to be perfectly sufficient for triggering the photocrosslinking reaction. It should be noted that in this specific case, the reaction is not instantaneous.

According to a particularity of the invention, the concentration of the reactive compound in the composition is between 0.1 and 20% by weight and preferably between 1 and 10%.

According to another particularity of the invention, the composition may also be provided with a photoinitiator of the reaction for crosslinking the grafted thermoplastic polyurethane. Of course, conventionally, the role of the photoinitiator is to generate free radicals under the effect of exposure to actinic radiation such as ultraviolet radiation.

In a particularly advantageous way, the photoinitiator may notably be selected from alpha-hydroxy ketones, alkylbenzoin ethers, alkylbenzyl ketals, acylphosphine oxides, arylphosphine oxides, benzophenone and its derivatives, xanthones and their derivatives.

According to another advantageous feature, the concentration of the photoinitiator in the composition is between 0.01 and 10% by weight and preferably between 1 and 5%.

According to another particularity of the invention, the composition may further be provided with a catalyst for the addition reaction between the polyisocyanate and the reactive compound.

In a particularly advantageous way, the catalyst is a derivative of tin, titanium, a base, an acid, or any mixture of these compounds.

Preferably, the catalyst is dibutyltin dilaurate, more commonly designated by the acronym DBTL.

According to another advantageous feature, the concentration of the catalyst in the composition is between 0.001 and 1% by weight.

The invention also relates to a method for making power and/or telecommunications cable cladding, a remarkable method in that it includes the steps of:

mixing a thermoplastic polyurethane, a polyisocyanate, as well as a reactive compound provided with at least one hydroxyl function and at least one acrylate function,

crosslinking the composition mixed beforehand with ultraviolet radiation.

In a particularly advantageous way, the manufacturing method further includes an addition step which consists of extruding the mixture as a cladding, said extrusion step being applied between the mixing step and the crosslinking step.

Other features and advantages of the present invention will become apparent during the description of the comparative example which will follow, said example being given as an illustration and by no means as a limitation.

### COMPARATIVE EXAMPLE

The goal is to determine and then to compare the thermomechanical performances of different thermoplastic polyurethanes capable of being used for making insulating claddings and/or for protecting power and/or telecommunications cables.

Preparation of the Compositions

In concrete terms, five mixtures E, F, G, H, E′ are prepared from five initial formulations A, B, C, D, A′ which differ from each other essentially by the nature of the epoxy acrylate resin used for grafting the basic thermoplastic polyurethane.

In order to avoid any untimely crosslinking, achievement of the mixtures E, F, G, H, E′ is carried out in two phases, with preliminary preparation of the formulations A, B, C, D, A′ integrating each epoxy acrylate resin, and then incorporation of a same isocyanate grafted thermoplastic polyurethane.

Table 1 specifically details the differences in compositions of the five basic formulations A, B, C, D, A′. In this respect, it should be noted that the amounts mentioned in the different tables appearing hereafter are conventionally expressed in parts by weight for a hundred parts by weight of thermoplastic polyurethane.

TABLE 1

| | Formulations | | | | |
|---|---|---|---|---|---|
| | A | B | C | D | A′ |
| Estane 58888 | 100 | 100 | 100 | 100 | 100 |
| CN133 | 6 | — | — | — | 6 |
| CN152 | — | 12 | — | — | |
| SR399 | — | — | 10 | — | |
| Lucirin TPO | 2 | 2 | 2 | — | 2 |
| DBTL (tin ppm) | 40 | 48 | 45 | 45 | 0 |

Estane 58888 is a thermoplastic polyurethane of the polyether type, which is distributed by Noveon. It is common to the five samples, and is notably used here as a matrix for the different mixtures E, F, G, H, E′.

Three types of resins enter these compositions. First of all, there is CN152, i.e., a monofunctional epoxy acrylate marketed by Cray Valley. A trifunctional epoxy acrylate is found next, distributed under the name of CN133 also by Cray Valley. Finally, SR399 is available, in other words dipentaerythritol penta-acrylate still marketed by Cray Valley.

As the crosslinking is performed in all the cases under ultraviolet radiation, initiation is systematically provided by a photoinitiator which here consists of triphenylphosphine oxide marketed under the brand Lucirin TPO by BASF.

As for the catalyst function, this is provided by DBTL, i.e., dibutyltin dilaurate. It should be noted that its proportions are exceptionally expressed here in ppm, because of the extreme smallness of the applied amounts.

As for Table 2, it details the compositions of five ultimate mixtures E, F, G, H, E′ which integrate the totality of the constituents intended to form the final materials.

TABLE 2

| | Mixtures | | | | |
|---|---|---|---|---|---|
| | E | F | G | H | E′ |
| Grafted Estane 58888 | 50 | 50 | 50 | 50 | 50 |
| A | 50 | — | — | — | |
| B | — | 50 | — | — | |
| C | — | — | 50 | — | |
| D | — | — | — | 50 | |
| A′ | | | | | 50 |

As suggested by its name, grafted Estane 58888 is a grafted derivative of the Estane 58888 thermoplastic polyurethane isocyanate described earlier. Its feature is that it integrates 3 parts by weight of diphenylmethane diisocyanate (MDI), as well as 3 parts of isophorone diisocyanate trimer (t-IPDI) for 100 parts of polymer.

Grafted Estane 58888 is intended to react with each type of selected resin, and this is why it is integrated in a second phase during the preparation of the different mixtures E, F, G, H, E′.

It is noted that the sample H contains neither resin nor photoinitiator. As such, it forms the reference sample of the comparative example.

Procedure

In concrete terms, the different mixtures E, F, G, H, E′ studied within the scope of the comparative example are all prepared by following the same procedure.

In each case, this begins by introducing the thermoplastic polyurethane in an internal mixer maintained at 180° C. Kneading is then carried out for 10 minutes, the temperature stabilizing at 185° C. The resin is then slowly added because of its low viscosity, in order not to lubricate the mixer. At the end of this operation, the photoinitiator is incorporated into the mixture at the same time as the catalyst, this in order to take into account the fact that said catalyst is used in a small amount and in that its viscosity is low. Kneading then continues for 15 minutes, before the mixture is finally removed from the mixer.

In a second phase, each mixture A, B, C, D, E′ obtained previously is reintroduced into the internal mixer maintained at 180° C., where it is kneaded for 10 minutes. Grafted Estane 58888 is then incorporated. It is then considered that 2 minutes are required for obtaining perfect fusion of the isocyanate grafted thermoplastic polyurethane and that 2 other minutes are absolutely necessary in order to achieve proper reaction between the isocyanate groups of the thermoplastic polyurethane and the hydroxyl groups of the resin.

Preparation of the Samples

Sample plates with a thickness of 1 mm are made by putting the different mixtures E, F, G, H, E′ under a press for 7 minutes, at a temperature of 200° C. and under a pressure of 100 bars. These plates are then irradiated under ultraviolet radiation in 1, 5, 10 and 20 passages and at a rate of 5 m/min, by means of a conveyer equipped with a 200 W/cm power lamp of the <<D>> type marketed by Fusion UV Systems.

Mechanical Properties

In order to check that real crosslinking has actually occurred, it appears to be relevant to proceed with a series of hot creep tests under mechanical stress, tests which are commonly designated by “Hot set Tests” and by the acronym HST.

Hot Creep Under Mechanical Stress at 175° C.

This type of test is governed by the NF EN 60811-2-1 standard. In concrete terms, it consists of weighing down an end of a H2 dumbbell type specimen with a mass corresponding to the application of an equivalent stress of 0.2 MPa, and to placing the whole in an oven heated to a set temperature to within +/−1° C. for a period of 15 minutes. At the end of this period, the hot elongation under stress of the specimen is reported, expressed in %. The suspended mass is then removed and the specimen is held in the oven for 5 further minutes. The residual permanent elongation, also called set, is then measured before being expressed in %.

It is recalled that the more a material is crosslinked, the smaller are the elongation and set values. Moreover it is specified that in the case when a specimen would break during a test or when its elongation would be larger than 100%, under the conjugate action of the mechanical stress and of the temperature, the result of the test would then be logically considered as a failure.

The results of the hot creep tests (hot set test) at 175° C., for the samples irradiated by 10 passages under the UV lamp, are recorded in Table 3 hereinbelow.

TABLE 3

Sample

| | E | F | H |
|---|---|---|---|
| Hot elongation (%) | 21 | 20 | Specimen |
| Set (%) | 8 | 12 | failure |

The results of the hot creep tests (hot set test) at 175° C., for the samples irradiated by 20 passages under the UV lamp, are recorded in Table 4 hereinbelow:

TABLE 4

| | Sample | | | | |
|---|---|---|---|---|---|
| | E | F | G | H | E′ |
| Hot | 7 | 19 | 11 | Specimen | 25 |
| elongation | | | | failure | |
| (%) | | | | | |
| Set (%) | 2 | 11 | 5 | | 14 |

First of all it is observed that unlike the control sample H, the three resin-based samples E, F, G successfully pass the hot set test at 175° C. In this respect, it should be noted that these good results are obtained independently of the fact that irradiation is performed in 10 or 20 passages.

Moreover, it is noted that for a given sample, the larger the irradiation, the smaller are the elongation and the set, which means that densification of the crosslinked network probably occurred.

It is also seen that the catalyst has well played its role since the elongation values after testing, as well as the set, are less for sample E than those obtained for sample E′. The additional reaction of the —OH groups on the —NCO is therefore optimized in the presence of the catalyst. Hot creep under mechanical stress at 200° C.

A second series of hot set tests are performed at a temperature which is set this time to 200° C. The results of the hot creep test, (hot set test) at 200° C., for the samples irradiated by 20 passages under the UV lamp, are recorded in Table 5 hereinbelow:

TABLE 5

| | Sample | | | |
|---|---|---|---|---|
| | E | F | G | H |
| Hot | 40 | Specimen | 50 | Specimen |
| elongation | | failure | | failure |
| (%) | | | | |
| Set (%) | 27 | | 30 | |

The results of the hot creep tests (hot set test) at 200° C. of the samples irradiated by 10 passages under the UV lamp are recorded in Table 6 herein below:

TABLE 6

| | Sample | | | |
|---|---|---|---|---|
| | E | F | G | H |
| Hot | 52 | Specimen | 70 | Specimen |
| elongation | | failure | | failure |
| (%) | | | | |
| Set (%) | 32 | | 30 | |

Unlike samples F and H, samples E and G perfectly pass the HST at 200° C. This proves to be rather surprising for polyurethanes, given the brittleness of the urethane bond already mentioned earlier, which is materialized by a strong tendency to open in the following way from 170° C.:

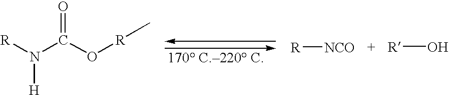

Hot Creep Under Mechanical Stress at 200° C. After Hot Irradiation

In order to be placed under conditions closer to those of industry, reducing the number of irradiations seems to be important. This goal may be achieved by performing hot ultraviolet irradiations. Indeed, it is known that from a thermodynamic point of view, the crosslinking reaction is promoted by heat.

In concrete terms, the samples E, G, H are raised to a temperature of about 120° C., before being irradiated only 5 times, directly at the oven outlet. A third series of hot set tests is then conducted, still at a temperature of 200° C. in order to be able to carry out an objective comparison with the previous test.

The results of the hot creep tests (hot set test) at 200° C., on the samples brought to 120° C. and then irradiated by 5 passages under the UV lamp, are recorded in Table 7 hereinbelow:

TABLE 7

Sample

| | E | G | H |
|---|---|---|---|
| Hot | 95 | 50 | Specimen |
| elongation | | | failure |
| (%) | | | |
| Set (%) | 70 | 35 | |

These results prove to be particularly interesting insofar that they show that samples E and G are capable of passing a hot set test at 200° C. with a low level of irradiations, even if this involves as a counterpart a certain deterioration of the elongation and of the set.

Rate of Insolubles

The rate of insolubles or the gel rate expresses the proportion of insoluble matter within a material. In the present case, with the knowledge of this rate, it is possible to quantify the crosslinking level of the corresponding polymer, being aware that the more a material is crosslinked, the higher and the closer to 100% is its rate of insolubles.

In practice, the procedure is identical for each measurement. In concrete terms, 1 g (M1) of each material is placed in an Erlenmeyer flask containing 100 g of tetrahydrofurane (THF) and the whole is refluxed at a temperature of 55° C., under magnetic stirring for a period of 24 h. The contents of the Erlenmeyer flask is then hot filtered on a metal grid for which the mesh size is 120 μm×120 μm. The obtained solid residue is then dried in an oven at 80° C. for 3 hours, and then weighed (M2). The rate of insolubles expressed in % is then calculated by taking the mass ratio M2×100/M1.

Within the scope of the comparative example, only materials which have successively passed the hot set test at 200° C., are tested, whether these are samples E and G irradiated 20 times or those having been subject to 5 hot irradiations. Table 3 groups the results of the different measurements.

TABLE 8

| | | initial | mass after | |
|---|---|---|---|---|
| | | mass M1 | test M2 | gel rate |
| Irradiation | Samp. | (g) | (g) | (%) |
| 20 passages | E | 1.010 | 0.936 | 93 |
| | G | 1.017 | 0.954 | 94 |
| 5 hot | E | 0.990 | 0.860 | 86 |
| passages | G | 1.000 | 0.960 | 96 |

In the case of samples E and G, irradiated 20 times, the high rate of insolubles illustrates very extreme crosslinking for both thermoplastic polyurethanes.

The conclusions are identical as regards the samples, subject to hot irradiation 5 times, with notably a particularly high rate of insolubles for sample G, which fully confirms the results obtained by this material during the hot set test at 200° C.

1. A power and/or telecommunications cable, comprising:
at least one cladding made by crosslinking a composition including a thermoplastic polyurethane, a polyisocyanate, as well as a reactive compound provided with at least one hydroxyl function and with at least one acrylate function.

2. The cable according to claim 1, wherein concentration of the reactive compound in the composition is between 0.1 and 20% by weight, and preferably between 1 and 10%.

3. The cable according to claim 1 wherein the composition includes a photoinitiator of the crosslinking reaction of grafted thermoplastic polyurethane.

4. The cable according to claim 3, wherein the photo-initiator is selected from alpha-hydroxy ketones, alkylbenzoin ethers, alkylbenzyl ketals, acylphosphine oxides, arylphosphine oxides, benzophenone and its derivatives, xanthones and their derivatives.

5. The cable according to any of claim 3 wherein the concentration of the photoinitiator in the composition is between 0.01 and 10% by weight, and preferably between 1 and 5%.

6. The cable according to claim 1, wherein the composition includes a catalyst for additional reaction between the polyisocyanate and the reactive compound.

7. The cable according to claim 6, wherein the catalyst is a derivative of tin, titanium, a base, an acid, or any mixture of these compounds.

8. The cable according to claim 6, wherein the catalyst is dibutyltin dilaurate.

9. The cable according to any of claim 6 wherein the concentration of the catalyst in the composition is between 0.001 and 1% by weight.

10. A method for manufacturing power and/or telecommunications cable cladding, comprising the steps of:
mixing a thermoplastic polyurethane, a polyisocyanate, as well as a reactive compound provided with at least one hydroxyl function and with at least one acrylate function,
crosslinking the composition mixed beforehand with ultraviolet radiation.

11. The manufacturing method according to claim 10, further comprising the step of extruding the mixture as cladding, said extrusion step being applied between the mixing step and the crosslinking step.
